(19) United States
(12) Patent Application Publication
(10) Pub. No.: US 2015/0088689 A1
(43) Pub. Date: Mar. 26, 2015

(54) Product Recognition Platform

(71) Applicant: Tech Masters International LLC, Boca Raton, FL (US)

(72) Inventors: Eduardo de Castro Leao Monteiro, New York, NY (US); Erico Sant'Anna Perrella, Sao Paulo (BR); Romulo Augusto de Carvalho Oliveira, Franco da Rocha (BR); Fabio Eduardo Elias, Sao Paulo (BR)

(73) Assignee: TECH MASTER INTERNATIONAL LLC, Boca Raton, FL (US)

(21) Appl. No.: 14/298,536

(22) Filed: Jun. 6, 2014

Related U.S. Application Data
(60) Provisional application No. 61/832,833, filed on Jun. 8, 2013.

(51) Int. Cl. G06Q 30/06

(52) U.S. Cl. CPC G06Q 30/0625; G06Q 30/0617
USPC 705/26.43; 705/26.62

(57) ABSTRACT

The method is a method for product recognition. The method includes receiving a product search request from a user. The method also includes performing an automatic search to identify the product. The method also includes generating an automatic search result. The method also includes analyzing an automatic search result of the automatic search to verify that the automatic search result satisfies a criterion for sending to the user. The method also includes sending the product search request to a human operator in response to a determination that the automatic search result fails to satisfy the criterion. The method also includes receiving an operator search result from the human operator. The method also includes sending the operator search result to the user.

### CROSS-REFERENCE TO RELATED APPLICATIONS

This application claims the benefit of U.S. Provisional Application No. 61/832,833, filed on Jun. 8, 2013, which is incorporated by reference herein in its entirety.

### BACKGROUND

Product recognition through user request is a simple and intuitive system for identifying products. It can be as simple as sending a picture or a text to a recognition service. However, conventional recognition systems that rely on live support operators are overly costly while purely automatic systems suffer from a relatively low accuracy rate. High cost in such a system is not sustainable and low rate of successful identification negatively affects the user experience rendering the system less attractive.

### SUMMARY

Embodiments of a method are described. In one embodiment, the method is a method for product recognition. The method includes receiving a product search request from a user. The method also includes performing an automatic search to identify the product. The method also includes generating an automatic search result. The method also includes analyzing an automatic search result of the automatic search to verify that the automatic search result satisfies a criterion for sending to the user. The method also includes sending the product search request to a human operator in response to a determination that the automatic search result fails to satisfy the criterion. The method also includes receiving an operator search result from the human operator. The method also includes sending the operator search result to the user. Other embodiments of the method are also described.

Embodiments of a system are described. In one embodiment, the system is a product recognition system. The system includes a database, a communication engine, an automatic search engine, and an operator interface engine. The communication engine receives a product search request. The automatic search engine executes an automatic search of a database to identify a product associated with the product search request. The operator interface engine sends the search request to a human operator in response to a determination that an automatic search result generated by the automatic search engine fails to satisfy a criterion for sending to a user. The operator interface facilitates generation of an operator search result. Other embodiments of the system are also described.

Embodiments of a computer program product are also described. In one embodiment, the computer program product includes a computer readable storage medium to store a computer readable program that, when executed on a computer, cause the computer to perform operations for recognizing a product. The operations receiving a product search request from a user. The operations also include performing an automatic search to identify the product. The operations also include analyzing an automatic search result of the automatic search to verify that the automatic search result satisfies a criterion for sending to the user. The operations also include sending the product search request to a human operator in response to a determination that the automatic search result fails to satisfy the criterion. The operations also include receiving an operator search result from the human operator. The operations also include sending the operator search result to the user. Other embodiments of the computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts schematic block diagram of one embodiment of a product recognition system.

FIG. 2 depicts a schematic block diagram of one embodiment of a communication engine.

FIG. 3 depicts a schematic block diagram of one embodiment of a training agent.

FIG. 4 depicts a flow chart diagram of one embodiment of a method for product recognition.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Reference to a computer readable medium may take any physical form capable of storing machine-readable instructions, at least for a time in a non-transient state, on a digital processing apparatus. A computer readable medium may be embodied by a compact disk, digital-video disk, a blu-ray disc, a magnetic tape, a Bernoulli drive, a magnetic disk, flash memory, integrated circuits, or other digital processing apparatus memory device.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the embodiments describe a product recognition system. The product recognition system allows a user to submit a description or image of an item and perform a search to identify the item. For example, a user may wish to know a product's source such as a brand or manufacturer. The user may want to know a product's model number or year, a version, a price, retail sources carrying the product, location, or other information about the product. While this is an attractive and simple way to obtain information on a product, conventional systems relying on automated identification of an object have a low rate of accurate image recognition and systems relying on live operators are overly expensive.

In some of the embodiments described herein, customers may submit product information to the product recognition system. The system stores the information in a database to provide a range of searchable information for users to identify products. In general, a user submits a product description or image to the system for identification and the system performs an initial automatic search across the compiled database. In some embodiments, the database has a specific scope. For example, a user may use a shoe searching application which will have a corresponding database which is directed substantially to shoes. This can improve search times and search result accuracy. The automatic search engine will attempt to match features and aspects of the product described by a user with information stored in the database in order to provide an accurate identification of the product. In some embodiments, the system will submit a result to the user for approval or rejection. If the system cannot find a suitable match, the information is forwarded to an operator for another search. If the user approves of the match generated by the automatic search, the acceptance is logged. If the user rejects the result from the automatic search engine, the system sends the product search to an operator.

In some embodiments, the operator is a live person. The operator receives the product search request and provides an operator search result to the user. If the operator search result is accepted, a system training agent logs the information into the database to improve the accuracy of the automatic search engine searching the same or similar products in the future. If the user rejects the operator search result, the system may present an error message to the user or send the product search along to a second operator or supervisor. A second operator or supervisor may look at the search result history, execute a new search, and provide a second operator result.

Advantages of the system include improved search result accuracy over conventional image recognition algorithms and reduced cost relative to operator-based systems. Some embodiments of the system include a learning process involving a training agent. The training agent logs successful operator search results to improve automatic search results in the future. Additionally, some embodiments of the training agent actively analyze the database for portions of the database needing additional information to improve searching. The training agent may then pass a training search request to an operator to provide the additional information to improve the database. In this way, the system is constantly improving efficiency and reducing cost. The system will also be able to handle a growing user and customer base as the automatic search becomes more effective and the database more comprehensive.

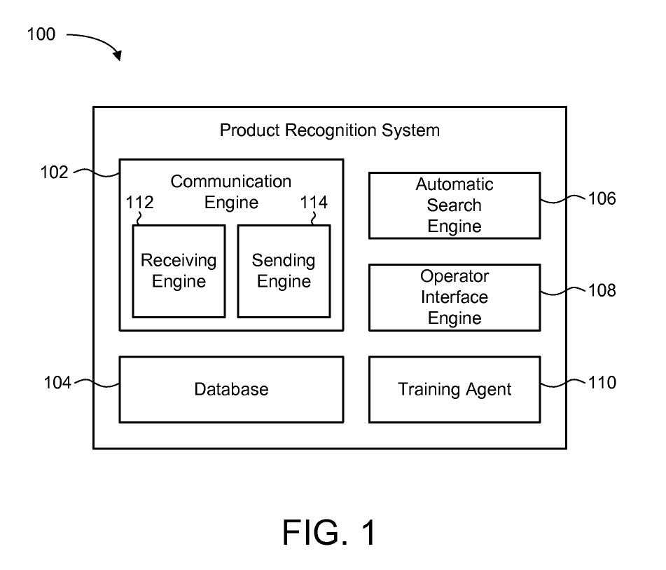

FIG. 1 depicts schematic block diagram of one embodiment of a product recognition system 100. The illustrated embodiment of the product recognition system 100 includes a communication engine 102, a database 104, an automatic search engine 106, an operator interface engine 108, and a training agent 110. The communication engine 102 includes a receiving engine 112 and a sending engine 114. The product recognition system 100 may be incorporated into a larger system or stand alone. In some embodiments, some or all of the components of the system 100 are implemented in a personal device. In other embodiments, some or all of components of the system 100 is stored on a server and accessed by local or remote devices via an application or other means.

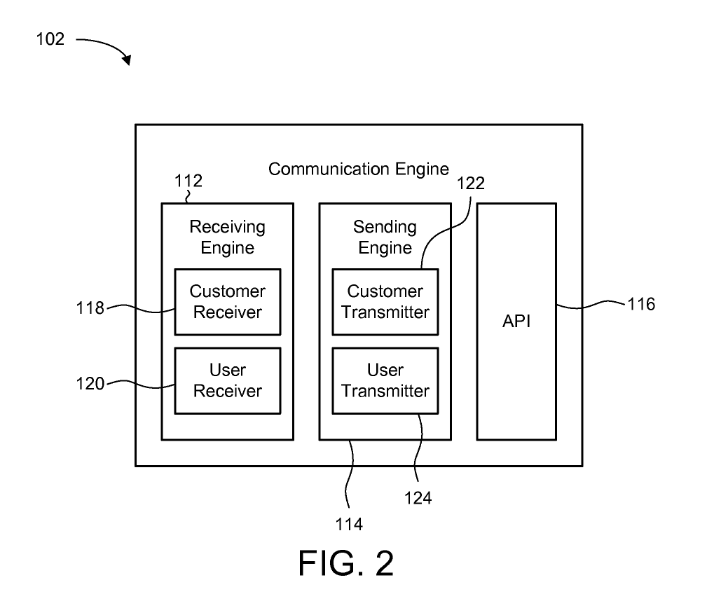

The communication engine 102 facilitates communication into and out of the product recognition system 100. The communication engine 102 is described in greater detail with respect to FIG. 2. In general, the communication engine 102 receives communication from customers, users, operators, applications, and other sources of information. In some embodiments, the receiving engine 112 may handle all incoming communications. In other embodiments, receiving operations may be shared among multiple portions of the communication engine 102. Embodiments of the sending engine 114 are similar in that some or all of the communication originating from the product recognition system 100 may be handled by the sending engine 114. In some embodiments, the communication engine 102 facilitates incoming customer information/updates and user search requests as well as outgoing search results and operator search forwards. The communication engine 102 may manage customer and user GUIs to make the communication process more intuitive. In some embodiments, the communication engine 102 may update or modify the data base 104 with information from customers or from search operations.

The database 104 stores information provided by customers and generated from searches. The database 104 may be a local storage system, a remote system, partitioned, cloud, or other system. The database 104 provides a search field for the automatic and operator searches. In some embodiments, searches are restricted to the database 104. In other embodiments, the database 104 is the primary search location with other locations such as the internet or other resources as secondary search locations. In some embodiments, the database 104 is a resource only accessed by the automatic search engine 106. Other usage schemes may be applied to the database 104.

In some embodiments, the database 104 is a dynamic database. In other words, the database 104 may change over time. The database 104 may include a manager (not shown) to constantly organize, update, clean, and restructure the database 104 to improve search efficiency and accuracy. For example, the automatic search engine 106 may provide results to the database 104 which may be organized within the database 104 under topics, categories, or other organizational or functional structures. Other structure and functionality may be incorporated into the database 104.

In some embodiments, the database 104 is dedicated to a specific product range. For example, the database 104 may be dedicated to storing information regarding vehicles. The database 104 may be accessed by a vehicle-specific searching application to identify images or descriptions of vehicles. Because this example of the database 104 is dedicated to vehicle-related searches, the chance of error by providing a non-vehicle result in a search result to a user is reduced. In some embodiments, information not related to vehicles or vehicle-related searches may be purged from the database 104. In other embodiments, the database 104 may be partitioned to create dedicated portions for searchable topics. For example, a vehicle database 104 may be partitioned into separate portions for cars, boats, and motorcycles to improve accuracy for each vehicle type. Such an embodiment can also provide benefits for customers. A customer who sells motorcycles and wishes to submit information to the database 104 from his/her inventory may submit the information with assurance that the information will reach their target market (people looking to identify motorcycles). The database 104 may be updated by the customer to reflect changes or improvements in the information pertaining to that customer on the database 104. The automatic search engine 106 then has access to updated information which improves search speed, accuracy, and user satisfaction.

The automatic search engine 106 receives a search query from the communication engine 102. The automatic search engine 106 attempts to detect aspects and features of a product image or description contained in the search query. The automatic search engine 106 then searches the database 104 for matching results. In some embodiments, certain criteria for matches are established. For example, to qualify as a matched result, a 50% correlation must be reached, or a certain number of aspects and features found, to correspond with an item in the database 104. Other matching criteria may be established.

In some embodiments, the automatic search engine 106 receives a search request from the communication engine 102. The automatic search engine 106 executes an automatic search based on the parameters submitted in the search request. In some embodiments, the search may be based on an image submitted by a user. In other embodiments, the search may be based on a textual description of a product. Other embodiments may execute the search given a barcode, voice description, model number or code, or other identifying information.

In one embodiment, the automatic search engine 106 searches the database 104. In some embodiments, the search request submitted to the automatic search engine 106 is deciphered by the communication engine 102 to identify aspects and features of the product described in the search request. In other embodiments, the automatic search engine 106 may decipher the search request to identify the aspects and features. For example, the search may be deciphered to identify product features such as color, shape, size, or other identifying aspects or descriptions. The automatic search engine 106 may identify a general category for the product and then narrow the search to specific models or products or perform a specific search on the entire database 104. Other search schemes may be applied to search for a product match. In some embodiments, the automatic search engine 106 may search the database 104 and a secondary resource such as the internet or other references or databases (not shown).

In some embodiments, the automatic search engine 106 may indicate to the user that the search may take a few moments. At this point, the communication engine may display an ad for the user to view while the search is completed. The user may elect to wait or have the system 100 provide the results once the search is completed. For example, the communication engine 102 may provide a push message to the user to communicate results or availability of results without the user needing to remain focused on the search. Other manners of communicating the result to the user may also be implemented. For example, the system 100 may email, make an automated call, provide a text message, or otherwise communicate the result to the user.

In some embodiments, if the automatic search engine 106 delays for an amount of time (predetermined or with relation to the complexity of the search) the system 100 will communicate a timeout or error message. This allows the user to be notified that the system is experiencing difficulties or is not available. In some embodiments, the error or timeout message may communicate to the user that the system 100 will be transferring the search request to an operator via the operator interface engine 108. In another embodiment, the error or timeout message may simply ask the user to resend the request or try again at another time. The error message may be a general message or may communicate some degree of detail to the user.

The automatic search engine 106 will attempt to generate one or more automatic search results. In some embodiments, the automatic search engine 106 executes one or more algorithms. If at least one match is found based on the search request, the result is communicated to the user by the communication engine 102 or another component of the product recognition system 100. In some embodiments, the product recognition system 100 may also prompt a user to provide feedback regarding the sufficiency of the result or results provided to them. In some embodiments, the user's selection of one result from a plurality of results is recorded by the system 100 to improve future search operations. In some embodiments, a lack of response from the user is considered to be a confirmation of at least one accurate result. In another embodiment, a lack of response may be interpreted as a request for further presentation of results. In some embodiments, if the user actively or passively indicates that the result is insufficient, the system 100 may pass the product search result to the operator interface engine 108.

In another embodiment, the user may not be prompted to provide feedback. In this embodiment, the system 100 may recognize a repeat of the same request from the user as indication that the first result was insufficient. In some embodiments, the system 100 may also recognize the repeat request and transfer the search request directly to the operator interface engine 108 bypassing the automatic search engine 106. The operator interface engine 108 would then function as the initial search resource for the user.

The illustrated embodiment of the operator interface engine 108 facilitates communication between the system 100 and an operator (not shown). The operator interface engine 108 facilitates transfer of the search request to an operator to allow the operator to search the database 104 or other resources in an attempt to identify the product described by the user in the search request. In some embodiments, the operator interface engine 108 communicates the insufficient automatic search results to the operator to facilitate a more efficient search by an operator. Providing the context of the rejected search results that were deemed insufficient by the user may assist the operator in narrowing down the search to more provide more accurate results.

In some embodiments, the operator interface engine 108 may include a graphical user interface (GUI) for the operator to receive the search request, view any results from the automatic search engine 106, perform a search of the database 104 and/or other resources, and submit results to the system 100 for communication to the user. In some embodiments, the operator interface engine 108 also provides information to the operator relating to training requests from the training agent 110 (discussed in more detail below). Other functionality may be incorporated into the operator interface engine 108.

The illustrated embodiment of the product recognition system also includes the training agent 110. In some embodiments, the training agent 110 is an automated system. In another embodiment, the training agent 110 is an interface for a human agent to interact with the product recognition system 100 in a trainer capacity.

In the automated system embodiment of the training agent 110, the agent 110 scans the database 104 for deficiencies in information stored in the database 104. The agent 110 identifies the deficiencies and creates a ticket or request detailing the deficiency. The deficiency is then communicated to the operator interface engine 108. The deficiency may be communicated directly from the agent 110 or through the communication engine 102 or some other component of the system 100 or outside of the system 100. In some embodiments, the request sent from the agent 110 is a training request detailing information needed to improve the database 104.

In the human embodiment of the training agent 110, the training agent 110 may be an interface through which a person may monitor the database 104 for deficiencies in the data. The person may use the training agent 110 to create a request for the operator interface engine 108 to address the deficiency. In some embodiments, the training agent 110 may be accessible to an operator at the operator interface engine 108. The operator may access the training agent 110 during periods of downtime at the operator interface engine 108. In other words, when the operator interface engine 108 has no pending requests, the operator may access the training agent 110 to search a request to provide data for the database 104. Other embodiments include other connections and functions of the training agent 110 and the interaction between the training agent 110 and the operator interface engine 108.

FIG. 2 depicts a schematic block diagram of one embodiment of a communication engine 102. The illustrated embodiment includes the receiving engine 112, the sending engine 114, and an API 116. The receiving engine 112 includes a customer receiver 118 and a user receiver 120. The sending engine 114 includes a customer transmitter 122 and a user transmitter 124. In general, the receiving engine 112 receives communications and the sending engine 114 transmits communications. The customer receiver 118 receives communications from the customer. For example, a customer may wish to list his/her products on the system 100 (of FIG. 1). The customer may transmit the product information to the communication engine 102. The customer receiver 118 would receive the communication from the customer and file the information into the database 104. In another embodiment, the customer receiver 118 perform a sorting operation on the information to check for new information not included in the database 104 and update the database 104 with the new information from the customer.

The user receiver 120 receives communications from a user. For example, if the user submits a search request, the request may be parsed at the user receiver to its relevant components and transmitted to the automatic search engine 106. In some embodiments, the user receiver 120 may check the communication from the user for format issues or other errors and ask the user to correct the problem. Some embodiments of the user receiver 120 provide communication management for multiple automatic search engines 106 and corresponding databases 104. For example, a single user receiver 120 may receive search requests. If the search requests apply to categories A, B, and C, the user receiver 120 may pass category A searches along to an automatic search engine 106 corresponding to category A while searches for category B and category C are passed to their own respective automatic search engines. In some embodiments, the user receiver 120 detects repeat searches from a user. The user receiver 120 may forward the repeat search request directly to the operator interface engine 108 or may send the information to the user transmitter to verify that the source of the search request is not a spam generator or other abusive source.

Similarly, the customer transmitter 122 and the user transmitter 124 facilitate outgoing communications with the customer and the user, respectively. For example, the customer transmitter 122 may request product updates from a customer to update the database 104. The customer transmitter 122 may also provide confirmation to the customer once their product information has been integrated into the database 104 or that a user was referred to one of the customer's products through the system 100. Other embodiments of the customer transmitter 122 may handle other communications going out to the customer.

The user transmitter 124 facilitates communications going to the user. The user transmitter 124 may communicate errors, confirmations, search results, status updates, initiate push notifications, send emails, make calls, provide ads to view during wait times, and/or request additional information from the user. In one embodiment, the user transmitter 124 may send an initial result to the user before engaging in a full product recognition search. For example, the user may send in an image of a white, long-sleeve t-shirt. The user transmitter 124 may send back a message from the system 100 saying “T-shirt, long-sleeve, white”. If the user confirms, the system 100 will go ahead with the product search to provide matches for the search. Other functionality may be incorporated into the user transmitter 124.

The illustrated embodiment of the API 116 is shown as part of the communication engine 102. In other embodiments, the API 116 may stand alone within the system 100, be external to the system 100, or be integrated with some other component of the system 100. The API 116 facilitates communication between the system 100 and another application. For example, the API 116 may facilitate communication with a mobile app run on a smart device such as a mobile phone or tablet. This would allow a user to initiate the search request from a smart device without compatibility issues. The ability to use the system 100 from a mobile device would also improve user traffic increasing exposure to customer products. This would increase the value of the system 100. The API 116 may also facilitate interaction with other platforms and applications.

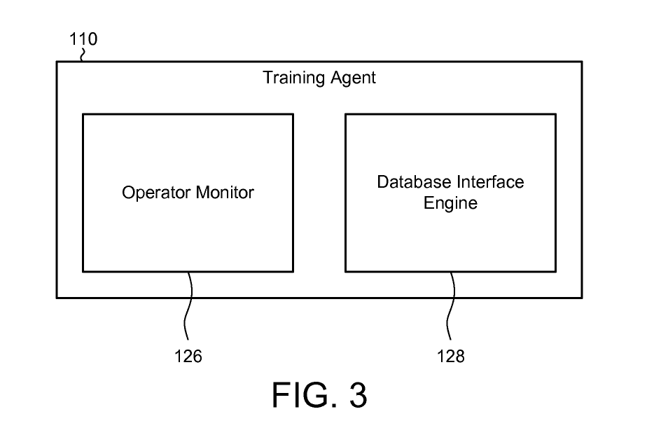

FIG. 3 depicts a schematic block diagram of one embodiment of a training agent 110. The illustrate embodiment of the training agent 110 includes an operator monitor 126 and a database interface engine 128. In some embodiments, the operator monitor 126 monitors the activity of an operator at an operator interface engine 108. If an operator is unoccupied, the operator monitor 126 may send a training request to the operator to provide information needed to fill out the database 104 to improve search accuracy. In another embodiment, the operator monitor 126 may track an operator's success with certain categories of products and refer products with which the operator is familiar to that particular operator.

The database interface engine 128 scans the database 104 for areas needing additional information to facilitate accurate searching. The database interface engine 128 may compile a list of areas needing supplemental information so that operators may access or receive the information during down times between searches. In some embodiments, the database interface engine 128 will record successful automatic and/or operator search results and correlate the results to the data in the database 104 to expand the database 104 and improve efficiency and accuracy of the product recognition system 100. The database interface engine 128 may provide other functionality.

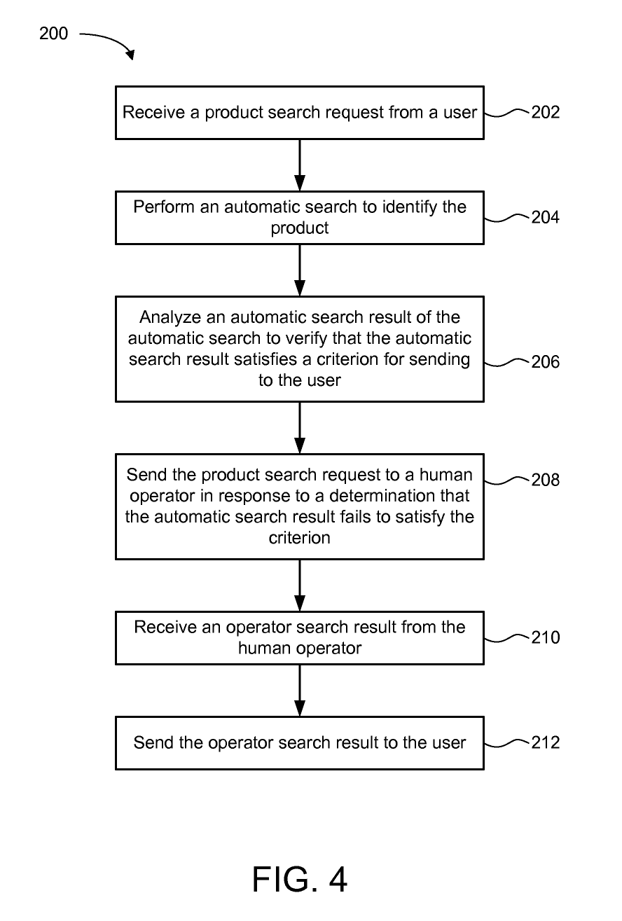

FIG. 4 depicts a flow chart diagram of one embodiment of a method for product recognition. Although the method 200 is described in conjunction with the product recognition system 100 of FIG. 1, embodiments of the method 200 may be implemented with other types of product recognition systems.

At block 202, a product search request from a user is received. At block 204 an automatic search is performed to identify the product. At block 206, the automatic search result is analyzed to verify that the automatic search result satisfies a criterion for sending to the user. At block 208, the product search request is sent to a human operator in response to a determination that the automatic search result fails to satisfy the criterion. At block 210, an operator search result from the human operator is received. At block 212, the operator search result is sent to the user.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a product recognition system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for product recognition, the method comprising:
receiving a product search request from a user;
performing an automatic search to identify the product;
analyzing an automatic search result of the automatic search to verify that the automatic search result satisfies a criterion for sending to the user;
sending the product search request to a human operator in response to a determination that the automatic search result fails to satisfy the criterion;
receiving an operator search result from the human operator; and
sending the operator search result to the user.

2. The method of claim 1, wherein performing the automatic search comprises searching a database.

3. The method of claim 2, wherein the database is configured to store only data relating to a specific product category.

4. The method of claim 2, further comprising:
analyzing the database with a training agent to detect a need for additional information to facilitate the automatic search, wherein the training agent is a human training agent or an automated training agent;
creating a training request;
sending the training request to the human operator; and
updating the database with information provided by the human operator in response to the training request.

5. The method of claim 1, wherein the criterion comprises a qualitative metric describing a degree of similarity between the product search request and an automatic search result.

6. The method of claim 1, further comprising analyzing the operator search result to verify that the operator search result satisfies the criterion and sending and error message in response to a determination that the operator search result fails to satisfy the criterion.

7. The method of claim 1, further comprising sending a message requesting a selection of at least one of a list of delivery types, the list comprising:
an instruction to display the search result to the user in an application;
a text message;
a voice call;
an email;
a push alert to open the application and display the search result; and
a wait-time advertisement.

8. An product recognition system comprising:
a database;
a communication engine to receive a product search request;
an automatic search engine to execute an automatic search of a database to identify a product associated with the product search request; and
an operator interface engine to send the search request to a human operator in response to a determination that an automatic search result generated by the automatic search engine fails to satisfy a criterion for sending to a user, wherein the operator interface facilitates generation of an operator search result.

9. The system of claim 8, further comprising a training agent to detect a need for additional information relating to a portion of the database, wherein the training agent is configured to send a training request to the human operator requesting that the human operator provide the additional information and provide the additional information to the training agent to update the database.

10. The system of claim 8, wherein the criterion comprises a qualitative metric describing a degree of similarity between the product search request and an automatic search result.

11. The system of claim 8, wherein the database is configured to store only data relating to a specific product category.

12. The system of claim 8, wherein an API facilitates communications with a customer and with a user.

13. The system of claim 8, wherein the communication engine comprises an API, wherein the API is configured to facilitate connections within the system and with an external application.

14. A computer program product comprising a computer readable storage medium to store a computer readable program that, when executed on a computer, causes the computer to perform operations for recognizing a product, the operations comprising:
receiving a product search request from a user;
performing an automatic search to identify the product;
analyzing an automatic search result of the automatic search to verify that the automatic search result satisfies a criterion for sending to the user;
sending the product search request to a human operator in response to a determination that the automatic search result fails to satisfy the criterion;
receiving an operator search result from the human operator; and
sending the operator search result to the user.

15. The computer program product of claim 14, wherein performing the automatic search comprises searching a database.

16. The computer program product of claim 15, wherein the database is configured to store only data relating to a specific product category.

17. The computer program product of claim 15, wherein the operations further comprise:
analyzing the database with a training agent to detect a need for additional information to facilitate the automatic search, wherein the training agent is a human training agent or an automated training agent;
creating a training request;
sending the training request to the human operator; and

18. The computer program product of claim 14, wherein the criterion comprises a qualitative metric describing a degree of similarity between the product search request and an automatic search result.

19. The computer program product of claim 14, wherein the operations further comprise analyzing the operator search result to verify that the operator search result satisfies the criterion and sending and error message in response to a determination that the operator search result fails to satisfy the criterion.

20. The computer program product of claim 14, wherein the operations further comprise sending a message requesting a selection of at least one of a list of delivery types, the list comprising:
an instruction to display the search result to the user in an application a text message;
a voice call;
an email;
a push alert to open the application and display the search result; and
a wait-time advertisement.
